(19) United States
(12) Patent Application Publication
(10) Pub. No.: US 2011/0055421 A1
(43) Pub. Date: Mar. 3, 2011

(54) Information processing apparatus, method for controlling information processing apparatus, and program

(75) Inventor: Kenichiro Takeda, Kawasaki (JP)

(73) Assignee: FUJITSU LIMITED, Kawasaki (JP)

(21) Appl. No.: 12/926,230

(22) Filed: Nov. 3, 2010

Related U.S. Application Data
(63) Continuation of application No. PCT/JP2008/059915, filed on May 29, 2008.

(51) Int. Cl. G06F 15/16

(52) U.S. Cl. 709/232

(57) ABSTRACT

Disclosed is an information processing apparatus including a communication unit connected to a transmission path and performs transmission and reception of communication data via the transmission path; a processing unit that performs processing of the communication data and non-communication data; a processing unit control part that causes the processing unit to perform the processing of the communication data and the non-communication data; and a communication unit control part that controls the communication unit, acquires a usage ratio, that represents a ratio of time required for performing the processing per unit time when the processing unit performs the processing of the communication data, from the processing unit control part, and sets a maximum data rate, that represents a maximum value of a data transfer amount per unit time to perform the transmission and reception of the communication data, based on the acquired usage ratio.

### CROSS-REFERENCE TO RELATED APPLICATION

This application is a U.S. continuation application filed under 35 U.S.C. 111(a) claiming benefit under 35 U.S.C. 120 and 365(c) of PCT application JP2008/059915, filed on May 29, 2008, the entire contents of which are incorporated herein by reference.

### FIELD

The embodiment discussed herein is related to an information processing apparatus, a method for controlling information processing apparatus, and a program.

### BACKGROUND

Up until now, there have been discussed CPU (Central Processing Unit) load control methods and devices for CPU load control methods to reliably control loads on CPUs. Further, there have been discussed reception interrupt processing units to minimize delay in reception time and reduce loads on CPUs.

Patent Document 1: Japanese Laid-Open Patent Publication No. 2001-14243

Patent Document 2: Japanese Laid-Open Patent Publication No. 2000-284976

### SUMMARY

According to an aspect of the present invention, there is provided an information processing apparatus including a communication unit connected to a transmission path and performs transmission and reception of communication data via the transmission path; a processing unit that performs processing of the communication data and non-communication data serving as data other than the communication data; a processing unit control part that causes the processing unit to perform the processing of the communication data and the non-communication data; and a communication unit control part that controls the communication unit, acquires a usage ratio, which represents a ratio of time required for performing the processing per unit time when the processing unit performs the processing of the communication data, from the processing unit control part, and sets a maximum data rate, which represents a maximum value of a data transfer amount per unit time to perform the transmission and reception of the communication data, based on the acquired usage ratio.

The object and advantages of the present invention will be realized and attained by means of the elements and combinations particularly pointed out in the claims.

It is to be understood that both the foregoing general description and the following detailed description are exemplary and explanatory and are not restrictive of the present invention as claimed.

### BRIEF DESCRIPTION OF DRAWINGS

FIG. 1 is a first block diagram illustrating the configuration of an information processing apparatus according to an embodiment;

FIG. 2 is second block diagram illustrating the configuration of the information processing apparatus according to the embodiment;

FIG. 3 is a diagram for illustrating the registration of the data transmission function of a network driver with a kernel;

FIG. 4 is a diagram for illustrating the registration of the data reception function of the network driver with the kernel;

FIG. 5 is a diagram for illustrating the measurement of data transmission sizes by the network driver;

FIG. 6 is a diagram for illustrating the measurement of the usage ratio of a CPU related to data transmission by the kernel;

FIG. 7 is a flowchart for illustrating the flow of an operation related to the comparison of the usage ratios of the CPU by the network driver;

FIG. 8 is a flowchart for illustrating the flow of the operation of the data transmission by the network driver;

FIG. 9 is a flowchart for illustrating the flow of the operation of abandoning data of a queue by the network driver when the queue is full of data items;

FIG. 10 is a flowchart for illustrating the flow of the operation of data reception by the firmware of the network adapter; and

FIG. 11 is a sequence diagram for illustrating the flow of an operation related to an actual example for setting a maximum data rate by the network driver.

### DESCRIPTION OF EMBODIMENTS

In the system of a server or the like where a network adapter is mounted, a network driver excessively consumes CPU resources, which in turn adversely affects other processing operated on a CPU. Specifically, there is a likelihood that the network driver excessively consumes the CPU resources at data transmission. Further, interrupt processing by the network driver is particularly likely to consume the CPU resources at data reception. Regarding such interrupt processing, there have been known methods for performing interrupt processing every certain time interval or every certain number of packets.

It is an object of the present invention to provide a configuration that can secure processing other than processing of communication data by reducing a load placed when a processing unit performs the processing of the communication data.

An information processing apparatus according to an embodiment dynamically changes a data transfer rate in consideration of the amount of CPU resources consumed by a network adapter and a network driver at data transmission/reception. Consequently, the information processing apparatus can control the data transfer rate at the data transmission/reception to be an optimum value in accordance with the performance of its CPU.

The information processing apparatus according to the embodiment can control the data transfer rate at the data transmission/reception to an optimum value regardless of a correlation between the performance of the CPU and the performance of the network driver. In other words, the information processing apparatus can reduce a transmission data size to an appropriate size in accordance with the performance of the CPU and reduce an interrupt amount related to the data reception to an appropriate amount in accordance with the performance of the CPU.

Here, the usage ratio of the CPU, which fluctuates in accordance with the value of a control parameter related to the interrupt of certain data reception, depends on the performance of the CPU. The information processing apparatus according to the embodiment is configured to set the value of the control parameter to an appropriate value to reduce the usage ratio of the CPU which fluctuates in accordance with the value of the control parameter related to the interrupt of certain data reception. According to the embodiment, the control parameter includes “maximum reception performance” or the like set in the network adapter.

In the information processing apparatus according to the embodiment, the network driver and the network adapter are configured to dynamically control the data transfer rate in accordance with the performance of the CPU. Thus, the information processing apparatus associates a “transmission data size,” an “interrupt amount related to the data reception,” and the “usage ratio of the CPU” with each other and dynamically changes the data transfer rate in accordance with the performance of the CPU, thereby controlling the usage ratio of the CPU to be an appropriate value.

Here, the “usage ratio of the CPU” refers to the ratio of time (expressed in %) required when the CPU performs specific processing to a unit time.

With respect to the information processing apparatus according to the embodiment, the user sets the upper limit of the usage ratio of the CPU capable of being allocated to the processing of communication data. Here, let it be assumed that the user sets the upper limit of the usage ratio of the CPU allocated to the processing of the communication data to be 60%. This setting is aimed at preventing the usage ratio of the CPU from exceeding 60% regardless of the traffic of an actual network. Thus, it becomes possible to allocate the remaining 40% of the usage ratio of the CPU to other data processing (such as application processing).

After the user's setting, the network driver notifies the user of the amount of the traffic of the communication data capable of being processed within the range of the usage ratio of the CPU in accordance with the setting.

For example, let it be assumed that the user uses the network adapter having a capacity of 10 Gbps (Giga bit per second) as the data transfer rate and sets the upper limit of the usage ratio of the CPU allocated to the processing of the communication data to be 50%. Here, if the maximum traffic amount of the communication data capable of being processed within a range where the upper limit of the usage ratio of the CPU is 5 Gbps, the network driver notifies the user of the value 5 Gbps. Similarly, let it be assumed that the user sets the upper limit of the usage ratio of the CPU capable of being allocated to the processing of the communication data to be 60%. Here, if the maximum traffic amount of the communication data capable of being processed within a range where the upper limit of the usage ratio of the CPU is 60%, the network driver notifies the user of the value 6 Gbps. Thus, when the user sets the upper limit of the usage ratio of the CPU capable of being allocated to the communication data, it is likely that the maximum performance 10 Gbps of the network adapter cannot be exerted.

The configuration of the information processing apparatus according to the embodiment is more specifically described below.

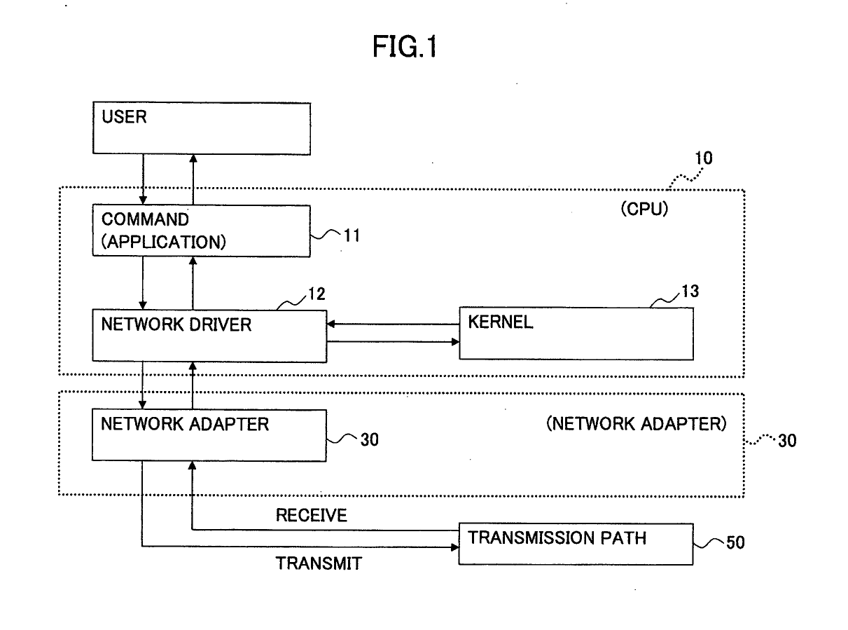

FIG. 1 is a block diagram illustrating the configuration of the information processing apparatus according to the embodiment.

As illustrated in FIG. 1, the information processing apparatus has a main body part 10 and a network adapter (sometimes referred to as a network card) 30. In the main body part 10, an OS (Operating System), an application 11 that processes a command related to an interface with the user, and a network driver 12 are mounted as software programs. The OS includes a kernel 13. Further, the network driver 12 is configured as a communication unit control part that controls the network adapter 30.

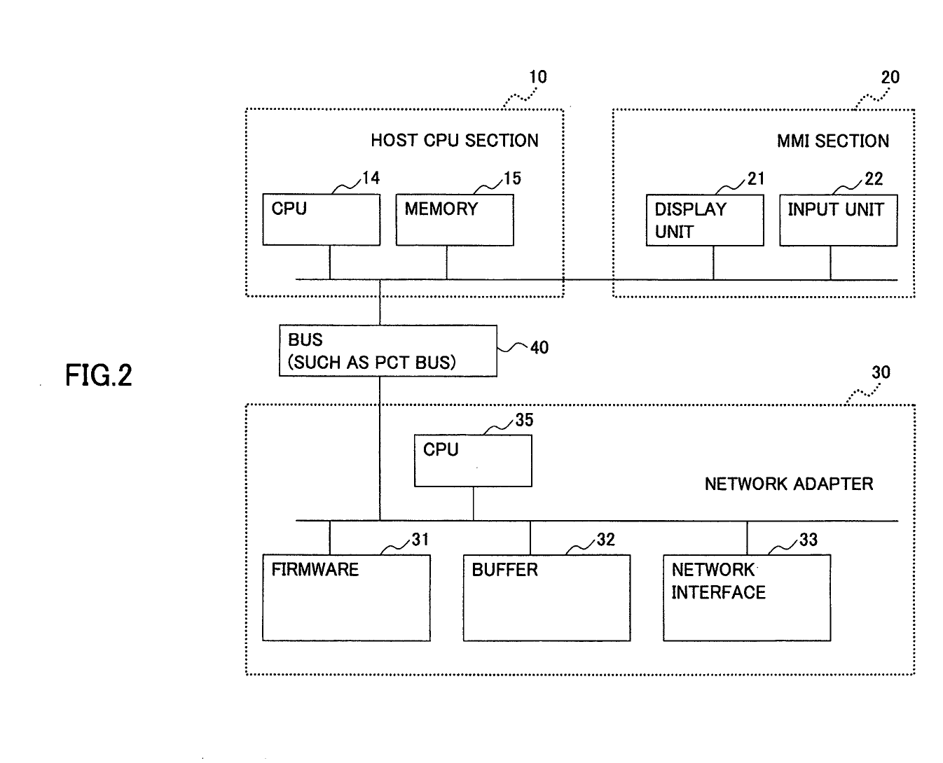

FIG. 2 is a block diagram illustrating the hardware configuration of the information processing apparatus.

As illustrated in FIG. 2, the information processing apparatus has a man-machine interface 20 and a bus 40 used for exchanging data between the main body part 10 and the network adapter 30, in addition to the main body part 10 and the network adapter 30 (referred also to as the network card).

The main body part 10 has a CPU 14 and a memory 15. By executing various programs held in the memory 15, the CPU 14 performs a control operation for controlling the whole information processing apparatus, various calculation processing, and the like. The various programs include the application 11 that processes a command, the network driver 12, and the OS including the kernel 13. The memory 15 includes a RAM, a ROM, and the like, holds the various programs executed by the CPU 14, and provides the CPU 14 with a work area.

The network adapter 30 includes a CPU 35, firmware 31, a buffer 32, and a network interface 33. The CPU 35, the firmware 31, the buffer 32, and the network interface 33 are configured as follows. In other words, they are configured to transmit and receive data to and from other information processing apparatuses via a transmission path 50 illustrated in FIG. 1 and give and receive the data to and from the network driver 12 of the main body part 10.

The man-machine interface 20 has a display unit 21 and an input unit 22. The display unit 21 is composed of a CRT, a liquid crystal display unit, and the like, and displays instruction information input by the user to the information processing apparatus via the input unit 22, a calculation processing result by the CPU 14, and the like. The input unit 22 includes a keyboard, a mouse, and the like, and is used when the user inputs various instruction information items to the information processing apparatus.

Hereinafter, the procedures of various control operations in the information processing apparatus are specifically described.

(1) Setting of Upper Limit of Usage Ratio of CPU Capable of being Allocated to Processing of Communication Data

In accordance with the user's setting of the upper limit of the usage ratio of the CPU 14 capable of being allocated to the processing of the communication data, the network driver 12 is configured to internally record a value related to the setting. Here, the user performs the setting by using the command or the like processed by the application 11.

Specifically, by using the display unit 21 and the input unit 22 of the man-machine interface 20, the user sets the upper limit of the usage ratio of the CPU 14 capable of being allocated to the communication data to the information processing apparatus. Here, the processing of the communication data is performed according to the configurations of the data transmission function and the data reception function, described below, of the network driver 12. The command used by the user for setting the upper limit of the usage ratio of the CPU 14 capable of being allocated to the processing of the communication data may include the following command. In other words, a command according to a technology such as a known ioctl (i.e., I/O control) may be used. Here, ioctl refers to a system call for sending and receiving data and a control instruction between a user space (such as a command) and a kernel space (such as a driver). The network driver 12 is configured to record as an internal variable the upper limit of the usage ratio of the CPU 14 capable of being allocated to the processing of the communication data thus set by the user.

(2) Registration of Data Transmission Function and Data Reception Function

The network driver 12 has the configurations of the data transmission function related to the processing of data transmission and the data reception function related to the processing of data reception. The network driver 12 is configured to register the data transmission function and the data reception function in the kernel 13 at its activation. This registration is performed so that the network driver 12 acquires from the kernel 13 the value of the usage ratio of the CPU 14 related to the processing of the communication data, which is described below with reference to FIG. 6. This registration is performed using an API (Application Programming Interface) provided between the network driver 12 and the kernel 13.

Details about the registration of the data transmission function and the data reception function are described below.

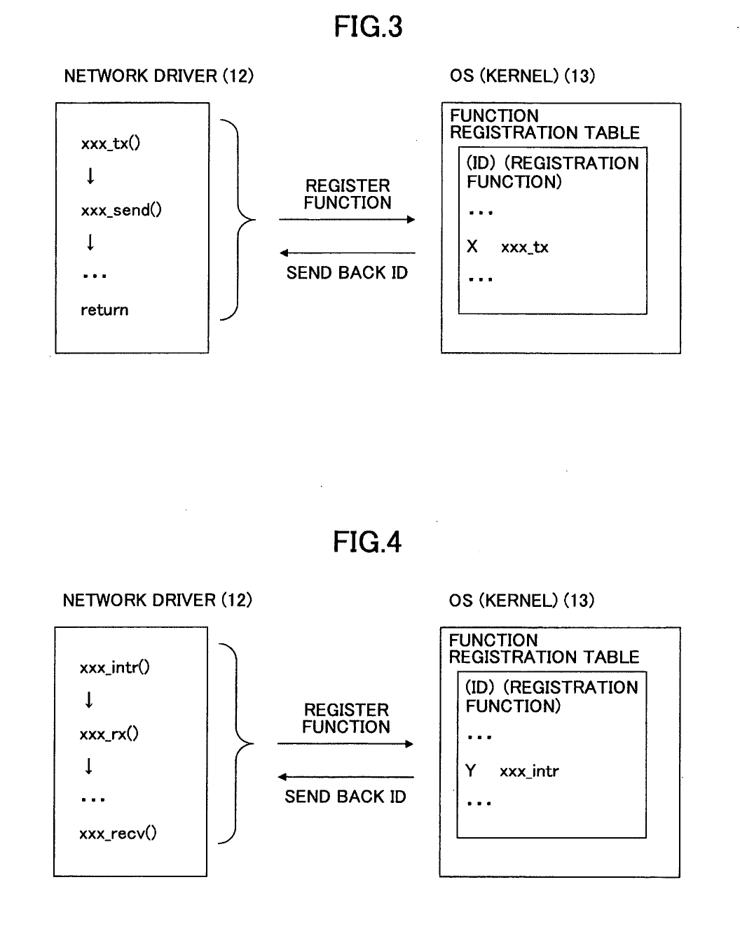

First, the registration of the data transmission function is described. The entry point (the part where the data transmission function is called by a high-order protocol or an application, i.e., “xxx_tx( )” in FIG. 3) of the data transmission function is registered in the kernel 13. The kernel 13 is configured to record a range from the entry point of the data transmission function to the part of “return” in FIG. 3 as a measurement object and send back an ID inherent in this recording to the network driver 12.

Next, the registration of the data reception function is described. In this case, an interrupt handler (“xxx_intr( )” in FIG. 4) serving as the call source of the data reception function is registered in the kernel 13. The kernel 13 is configured to record a range from the interrupt handler to the part (i.e., “xxx_recv( )” in FIG. 4) where the network driver 12 provides a high-order protocol or an application with data as a measurement object and send back an ID inherent in this recording to the network driver 12.

(3) Measurement of Data Size Related to Transmission/Reception

The network driver 12 is configured to periodically record data sizes transmitted/received in a certain time after the registration of the data transmission function and the data reception function with the kernel 13 in accordance with the procedure (2) described above.

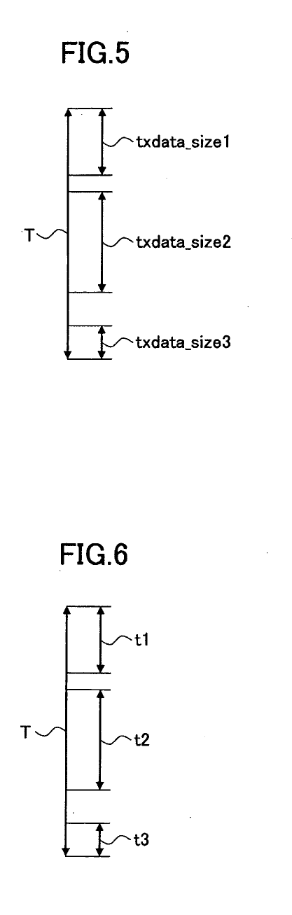

The measurement of data sizes related to the data transmission is described with reference to FIG. 5. Here, the data sizes (hereinafter referred to as transmission data sizes) of data items transmitted to the transmission path 50 via the network adapter 30 in the certain time T are measured. In an example illustrated in FIG. 5, the data having a data size as indicated by “txdata_size1” are transmitted in the first time period of the certain time T. Next, the data having a data size as indicated by “txdata_size2” are transmitted. Then, the data having a data size as indicated by “txdata_size3” are transmitted in the last time period of the certain time T.

The network driver 12 has a variable (“txdata_size_sum”) indicating the sum of the transmission data sizes of data items. The network driver 12 is configured to update the variable every time data are transmitted via the network adapter 30. In the case of the example illustrated in FIG. 5, the sum of the transmission data sizes of the data items transmitted in the certain time T is calculated by the following formula.

txdata_size_sum=taxdata_size1+txdata_size2+txdata_size3

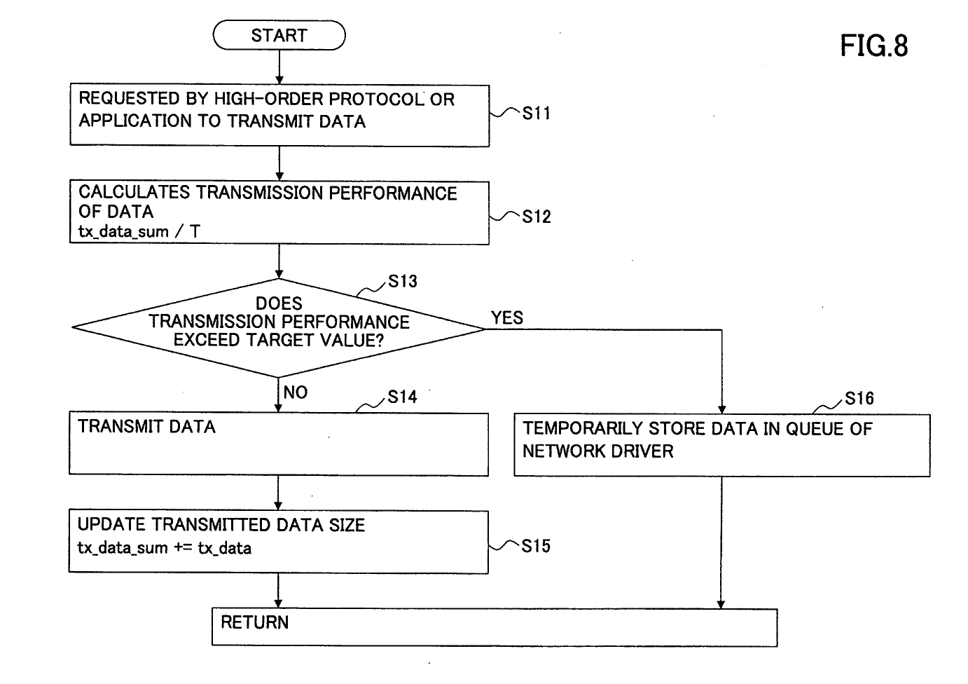

The variable “txdata_size_sum” indicating the sum of the transmission data sizes of the data items thus calculated is used in the operation of the data transmission (step S12) described below with reference to FIG. 8.

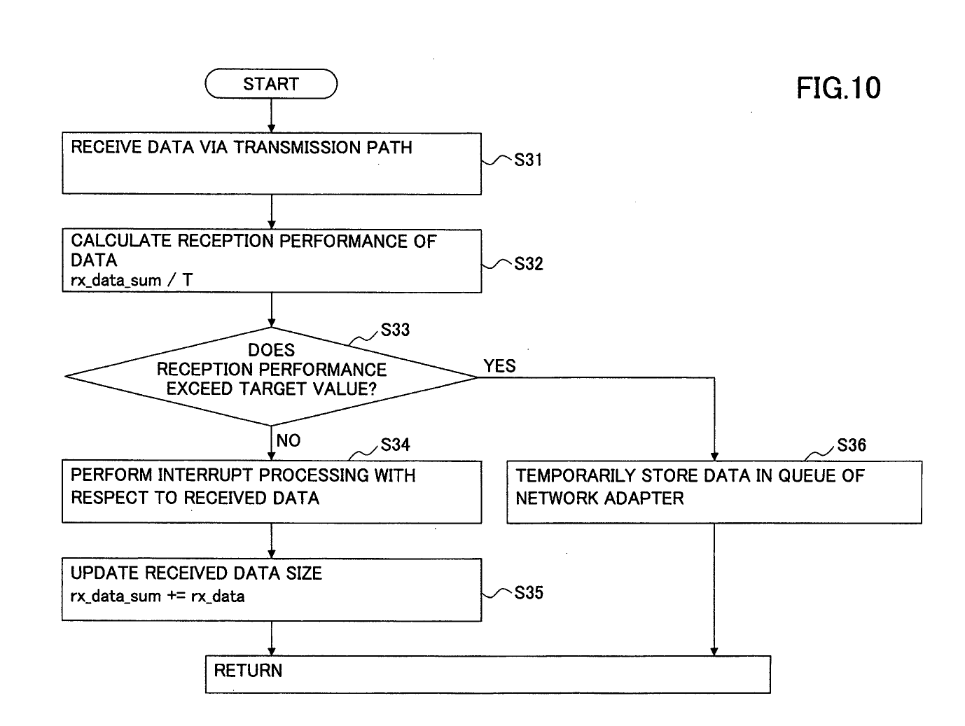

Further, the sum of data sizes (hereinafter referred to as reception data sizes) of data items related to the data reception is calculated in the same manner as the above. Data received from an outside via the transmission path 50 are first processed by the network adapter 30. Here, the firmware of the network adapter 30 is configured to perform interrupt processing (step S34 in FIG. 10) on the network driver 12 with respect to the data received. The network driver 12 is configured to receive the interrupt processing at the part of the interrupt handler described above with reference to FIG. 4. Further, the data reception function of the network driver 12 is configured to pass the data to the high-order protocol or the application after the reception of the data related to the interrupt processing. The firmware 31 of the network adapter 30 calculates the reception data sizes of data items which are received from the transmission path and for which the interrupt processing is performed on the network driver 30. The variable “rxdata_size_sum” indicating the sum of the reception data sizes is used in the operation (step S32) of the data reception by the firmware 31 described below with reference to FIG. 10.

(4) Measurement of Usage Ratio of CPU

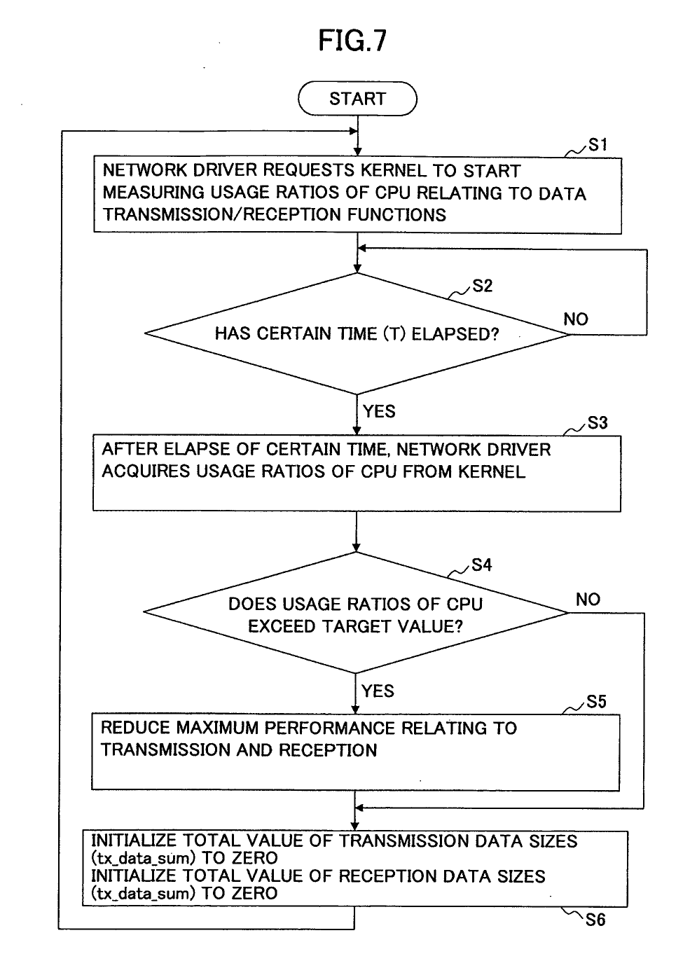

As for the operation of the CPU 14 related to the processing of the communication data by the network driver 12, the kernel 13 periodically measures and records the ratio of communication data the operating time of the CPU 14 to the total operating time of the CPU 14 in the certain time T described above. Note that the operation of measuring and recording the ratio of the communication data operating time of the CPU 14 to the total operating time of CPU 14 is performed every elapse of the certain time T in the operation of comparing the usage ratios of the CPU 14 described below with reference to FIG. 7. Here, the usage ratio of the CPU 14 refers to the ratio of the time required when the CPU 14 performs an operation related to a specific function (such as the data transmission function and the data reception function) in the certain time T. Note that the data transmission function and the data reception function are registered in the kernel 12 in accordance with the procedure (2) described above as illustrated in FIGS. 3 and 4.

FIG. 6 is a diagram for illustrating the measurement of the usage ratio of the CPU 14. In FIG. 6, a certain time T is identical to the certain time T illustrated in FIG. 5. Similar to the case of FIG. 5, the kernel 13 measures the operating time of the CPU 14 related to the processing of the specific function when the CPU 14 performs the data transmission processing via the network adapter 30 in the certain time T. In an example illustrated in FIG. 6, a time period t1 in the certain time T indicates the operating time of the CPU 14 related to the transmission of the data having the data size as indicated by “txdata_size1” described with reference to FIG. 5. Similarly, a time period t2 in the certain time T indicates the operating time of the CPU 14 related to the transmission of the data having the data size as indicated by “txdata_size2” described with reference to FIG. 5. Further, a time period t3 in the certain time T indicates the operating time of the CPU 14 related to the transmission of the data having the data size as indicated by “txdata_size3” described with reference to FIG. 5.

The kernel 13 has a variable (cpu_usage[ID]) indicating the usage ratio of the CPU 14 for each ID of the functions (the data transmission function and the data reception function) registered as described above. In the case of the example illustrated in FIG. 6, the usage ratio of the CPU 14 is measured by the following formula.

cpu_usage[ID](%)=(t1+t2+t3)/T

The usage ratio of the CPU 14 thus measured is used in the operation (steps S3 and S4) of comparing the usage ratios of the CPU 14 described below with reference to FIG. 7.

(5) Setting of Maximum Data Rate

The network driver 12 acquires the usage ratio of the CPU 14 related to the processing of the data transmission function and the data reception function registered in accordance with the procedure (2) described above, i.e., acquires the usage ratio of the CPU 14 related to the processing of the communication data periodically, i.e., every elapse of the certain time T. In other words, the network driver 12 acquires the “usage ratio of the CPU 14 related to the operation of the data transmission function in the certain time T” measured and recorded by the kernel 13 in accordance with the procedure (4) described above. In addition, the network driver 12 acquires the “usage ratio of the CPU 14 related to the operation of the data reception function in the certain time T” measured and recorded by the kernel 13 in accordance with the procedure (4) described above. Then, the network driver 12 compares the usage ratio of the CPU 14 related to the operation of the data transmission function and the usage ratio of the CPU 14 related to the operation of the data reception function thus acquired with the “upper limit of the usage ratio of the CPU 14” set by the user in accordance with the procedure (1) described above.

If the result of the comparison shows that the usage ratio of the CPU 14 related to the operation of the data transmission function thus acquired does not exceed the upper limit of the usage ratio of the CPU 14 set by the user, the network driver 12 maintains as an optimum value the setting value of the maximum value of a data transmission rate at that point (referred to as a maximum data rate related to the data transmission). On the other hand, if the result of the comparison shows that the usage ratio of the CPU related to the operation of the data transmission function thus acquired exceeds the upper limit of the usage ratio of the CPU 14 set by the user, the network driver 12 reduces the setting value of the maximum data rate related to the data transmission by a predetermined rate. Details about this are described later with reference to FIG. 7.

Here, the setting value of the maximum data rate related to the data transmission is used as the “target value of the transmission performance” in the operation (step S13) of the data transmission described below with reference to FIG. 8. Further, the setting value of the maximum data rate related to data transmission is appropriately adjusted as the value of maximum performance related to the transmission out of the maximum performance related to the transmission and the reception in the operation (step S5) of comparing the usage ratios of the CPU 14 described below with reference to FIG. 7.

If the result of the comparison shows that the usage ratio of the CPU 14 related to the operation of the data reception function thus acquired does not exceed the upper limit of the usage ratio of the CPU 14 set by the user, the network driver 12 maintains as an optimum value the setting value of the maximum value of a data transmission rate at that point (referred to as a maximum data rate related to the data reception). On the other hand, if the result of the comparison shows that the usage ratio of the CPU related to the operation of the data reception function thus acquired exceeds the upper limit of the usage ratio of the CPU 14 set by the user, the network driver 12 reduces the setting value of the maximum data rate related to the data reception by a predetermined rate. Details about this are described later again with reference to FIG. 7.

Here, the setting value of the maximum data rate related to the data reception is used as the “target value of reception performance” in the operation (step S33) of the data reception by the firmware 31 described below with reference to FIG. 10. Further, the setting value of the maximum data rate related to the data reception is appropriately adjusted as the value of maximum performance related to the reception out of the maximum performance related to the transmission and the reception in the operation (step S5) of comparing the usage ratios of the CPU 14 described below with reference to FIG. 7.

In acquiring the usage ratio of the CPU 14 from the kernel 13, the network driver 12 uses the API and the ID corresponding to the functions (the data transmission function and the data reception function) acquired from the kernel 13 in accordance with the procedure (2) described above. In other words, the network driver 12 queries the kernel 13 about the value of the usage ratio of the CPU 14 by specifying the corresponding functions. In response to this, the kernel 13 sends back the value of the usage ratio of the CPU 14, which is measured and recorded in the procedure (4) described above and relates to the corresponding functions, to the network driver 12.

Next, the flows of the operations of the procedures (3) through (5) described above are described with reference to flowcharts illustrated in FIGS. 7 through 10. Note that the operations of the flowcharts illustrated in FIGS. 7 through 10 are simultaneously performed in parallel to each other.

First, the flow of the operation of comparing the usage ratios of the CPU 14 is described with reference to FIG. 7.

By using a timer function or the like, the network driver 12 compares the values of the usage ratios of the CPU 14 acquired in the certain time with the upper limit of the usage ratio of the CPU 14 set by the user periodically, i.e., every elapse of the certain time T. Then, the network driver 12 appropriately adjusts the setting value of the maximum data rate related to the data transmission or the maximum data rate related to the data reception in accordance with the result of the comparison.

In other words, in step S1 of FIG. 7, the network driver 12 instructs the kernel 13 to perform the procedure (4) described above, i.e., the procedure of measuring the usage ratio of the CPU 14. Then, the network driver 12 determines whether the certain time T has elapsed (step S2). After the elapse of the certain time T, the network driver 12 acquires from the kernel 13 the value of the usage ratio of the CPU 14 related to the operation of the data transmission function and the value of the usage ratio of the CPU 14 related to the operation of the data reception function (step S3).

Next, in step S4, in accordance with the procedure (5) described above, the network driver 12 compares the values of the usage ratios of the CPU 14 thus acquired with the upper limit of the usage ratio of the CPU set by the user in accordance with the procedure (1) described above. If the result of the comparison shows that the values of the usage ratios of the CPU 14 do not exceed the upper limit, the flow proceeds to step S6 described below. On the other hand, if the result of the comparison shows that the values of the usage ratios of the CPU 14 exceed the upper limit, the flow proceeds to step S5. In step S5, if the result of the comparison shows that the value of the usage ratio of the CPU 14 related to the operation of the data transmission function exceeds the upper limit, the network driver 12 reduces the maximum data rate related to the data transmission by a predetermined rate. Note that in the operation of the data transmission described below with reference to FIG. 8, the maximum data rate related to the data transmission is compared in step S13 with actual transmission performance related to calculation in step S12 as the target value of the transmission performance. Here, if the actual transmission performance related to the calculation exceeds the target value, the data related to the current transmission request are not transmitted (step S16).

Similarly, in step S5, if the result of the comparison shows that the value of the usage ratio of the CPU 14 related to the operation of the data reception function exceeds the upper limit, the network driver 12 reduces the maximum data rate related to the data reception by a predetermined rate. Note that in the operation of the data reception by the firmware 31 of the network adapter 30 described below with reference to FIG. 10, the maximum data rate related to the data reception is compared in step S33 with actual reception performance related to calculation in step S32 as the target value of the reception performance. Here, if the actual reception performance related to the calculation exceeds the target value, the data related to the current reception are stored in the queue of the network adapter 30 (step S36). In this case, the interrupt processing is not performed on the network driver 12 with respect to the data received, which in turn does not place a load on the CPU 14.

In step S6, the variable indicating the sum of the transmission data sizes of the data items and the variable indicating the sum of the reception data sizes of the data items recorded in accordance with the procedure (3) described above are initialized to zero, the reason for which is described below.

The user can previously specify the respective setting values of the maximum data rate related to the data transmission and the maximum data rate related to the data reception as external variables. Further, the network driver 12 previously has as a default value the value of a predetermined rate serving as a reduction range for reducing the setting values of the maximum data rates (step S5), but the user may specify the value as an external variable.

As described below with reference to FIG. 8, in the case of the data transmission, the network driver 12 calculates the transmission performance of data items until that point every transmission of data (S12). Similarly, as described below with reference to FIG. 10, in the case of the data reception, the firmware 31 calculates the reception performance of data items until that point every time the network adapter 30 receives data (step S32).

Since the network driver 12 determines whether the certain time T has elapsed in step S2 as described above, the operation of FIG. 7 is performed every elapse of the certain time T. As a result, the variable indicating the sum of the transmission data sizes and the variable indicating the sum of the reception data sizes are initialized to zero every elapse of the certain time T. Accordingly, every elapse of the certain time T, the network driver 12 can obtain the transmission performance in the certain time T in the operation of the data transmission described below with reference to FIG. 8. This is because the transmission performance, which is calculated in step S12 of FIG. 8 at the transmission of the data immediately before the variable indicating the sum of the transmission data sizes is initialized to zero, indicates the transmission performance every elapse of the certain time T as described below.

Similarly, at every elapse of the certain time T, the firmware 31 of the network adapter 30 can obtain the reception performance in the certain time T in the operation of the data reception described below with reference to FIG. 10. This is because the reception performance, which is calculated in step S32 of FIG. 10 at the reception of the data immediately before the variable indicating the sum of the reception data sizes is initialized to zero, indicates the transmission performance every elapse of the certain time T as described below. In the case of the data reception, however, the sum of the reception data sizes refers to the sum of the reception data sizes of the data items for which the firmware 31 performs the interrupt processing on the network driver 12 in accordance with the data reception.

Note that in the embodiment, the network driver 12 is configured to perform the processing of initializing the variable indicating the sum of the transmission data sizes and the variable indicating the sum of the reception data sizes to zero in step S6 of FIG. 7. Other than this configuration, the network driver 12 may be configured as follows. In other words, the network driver 12 is configured to perform the processing of initializing the variable indicating the sum of the transmission data sizes to zero in the same manner as described above. On the other hand, the network adapter 30 is configured to perform the processing of initializing the variable indicating the sum of the reception data sizes to zero. In the case of this configuration, the network adapter 30 has a timer, and the timer initializes the variable “rx_data_sum” indicating the sum of the reception data sizes to zero every elapse of the certain time T.

Next, the flow of the operation of the data transmission by the network driver 12 is described with reference to FIG. 8.

When requested by the high-order protocol, the application, or the like to transmit data (step S11), the network driver 12 first calculates the transmission performance until that point (step S12). As described above, the network driver 12 has the variable (txdata_size_sum) indicating the sum of the transmission data sizes. The variable indicating the sum of the transmission data sizes is initialized to zero in step S6 of FIG. 7. In the certain time T until the variable is thus initialized, the variable indicating the sum of the transmission data sizes is updated and gradually increased with the addition of a data size related to the transmission every time data are transmitted (step S15). In step S12, the value of the variable indicating the sum of the transmission data sizes is divided by the value of the certain time T. Accordingly, until the variable indicating the sum of the transmission data sizes is initialized to zero every elapse of the certain time T, the transmission performance calculated in step S12 every time data are transmitted is also gradually increased in proportion to the increase in the value of the variable indicating the sum of the transmission data sizes. Then, the transmission performance, which is calculated in step S12 of FIG. 8 at the transmission of the data immediately before the variable indicating the sum of the transmission data sizes is initialized to zero, indicates the transmission performance every elapse of the certain time T as described below.

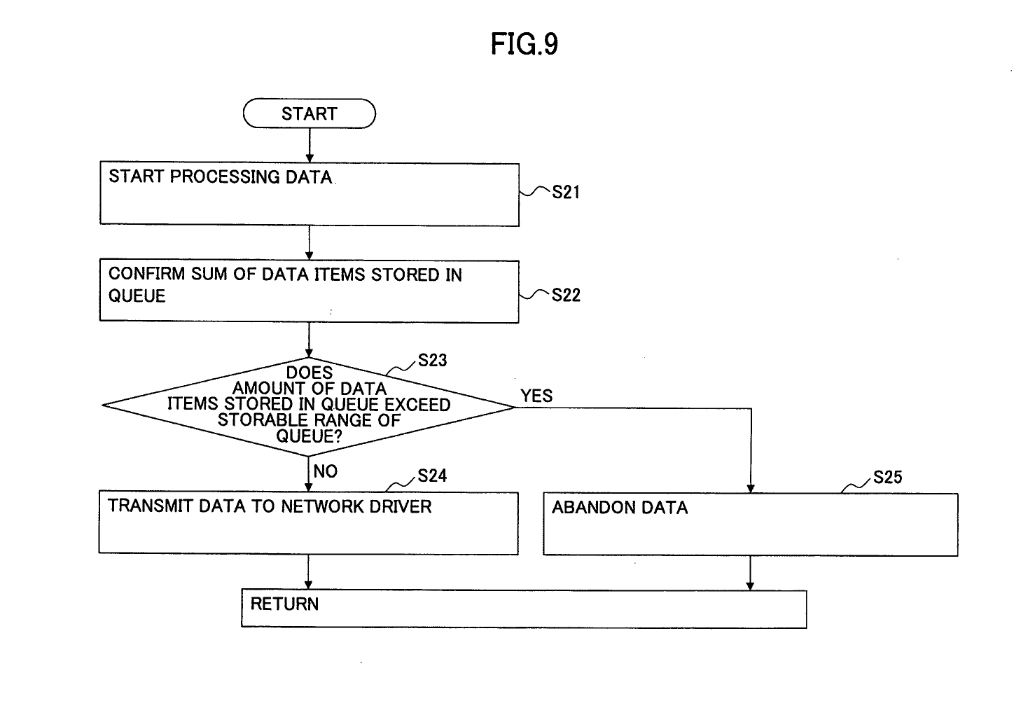

In step S13, a determination is made as to whether the transmission performance calculated in step S12 exceeds the maximum data rate related to the data transmission set as the “data size of the data capable of being transmitted in the certain time.” Here, let it be assumed that the transmission performance exceeds the maximum data rate related to the data transmission because the transmission performance calculated in step S12 is increased in accordance with the data transmission request from the high-order protocol or the application. In this case (Yes in step S13), the flow proceeds to step S16, and the network driver 12 does not transfer the data related to the transmission request in step S11 to the network adapter 30. Here, the data are temporarily stored in the predetermined queue of the network driver 12. When the queue is full of data items, the high-order protocol or the application detects this state. The operation of detecting the state is described below with reference to FIG. 9.

On the other hand, if the result of the determination in step S13 shows that the transmission performance does not exceed the maximum data rate (No in step S13), the data related to the request in step S11 are transferred to the network adapter 30 and then transmitted to the transmission path 50 via the network adapter 30 (step S14). In this case, with the addition of the data size related to the transmission as described above, the variable indicating the sum of the transmission data sizes is updated. Note that the “data” refers to variable-length data less than or equal to an upper limit determined by the high-order protocol or the application.

FIG. 9 is a flowchart for illustrating the operation of the high-order protocol or the application when the queue described above is full of data items. In this case, the procedure of the operation can be a known one. In other words, if it is detected that the queue is full of data items, a method (1) for suspending the transmission request or a method (2) for abandoning the data is employed. FIG. 9 illustrates an example in which the method (2) for abandoning the data is employed.

The high-order protocol or the application performs the operation of FIG. 9 before requesting the network driver 12 to transmit the data in step S11 of FIG. 8. In FIG. 9, the high-order protocol or the application starts the processing of the data (step S21). Then, the high-order protocol or the application confirms the sum of the data items stored in the queue (step S22) and determines whether the sum of the data items stored in the queue exceeds a threshold indicating the storable range of the queue (step S23). If the result of the determination shows that the sum of the data items does not exceed the threshold, the high-order protocol or the application requests the network driver 12 to transmit the data in step S24. When requested by the high-order protocol or the application to transmit the data, the network driver 12 starts the operation of the data transmission described above with reference to FIG. 8.

On the other hand, if the result of the determination shows that the sum of the data items exceeds the threshold, i.e., if the queue is full of data items, the high-order protocol or the application abandons the data (step S25).

Note that when the method (1) for suspending the transmission request is employed, the high-order protocol or the application performs the following operation instead of step S25. In other words, the high-order protocol or the application repeatedly performs the operation of temporarily suspending the transmission request, starting again the flow of FIG. 9 after the elapse of the certain time, and making the determination of step S23. If the full-state of the queue is eliminated in the meantime, the high-order protocol or the application performs the operation of step S24 to request the network driver 12 to actually transmit the data.

Next, the flow of the operation of the data reception by the firmware 31 of the network adapter 30 is described with reference to FIG. 10. In the case of the data reception, the network driver 12 first sets in the network adapter 30 the “data size of the data capable of being received in the certain time” as the maximum data rate related to the data reception. Then, the firmware 31 of the network adapter 30 performs the following operation.

In other words, when the network adapter 30 receives the data via the transmission path 50 (step S31), the firmware 31 first calculates the reception performance until that point (step S32). As described above, the firmware 31 has the variable (rxdata_size_sum) indicating the sum of the reception data sizes. The variable indicating the sum of the reception data sizes is initialized to zero in step S6 of FIG. 7. In the certain time T until the variable is thus initialized, the variable indicating the sum of the reception data sizes is updated and gradually increased with the addition of a data size related to the data reception every time data are received and the corresponding interrupt processing is performed on the network driver 12 (step S35).

In step S32, the value of the variable indicating the sum of the reception data sizes is divided by the value of the certain time T. Accordingly, until the variable indicating the sum of the reception data sizes is initialized to zero every elapse of the certain time T, the reception performance, which is calculated in step S32 every time data are received and the interrupt processing is performed, is also gradually increased in proportion to the increase in the value of the variable indicating the sum of the reception data sizes. Then, the reception performance, which is calculated in step S32 of FIG. 10 at the reception of the data immediately before the variable indicating the sum of the reception data sizes is initialized to zero, indicates the reception performance every elapse of the certain time T as described above.

In step S33, a determination is made as to whether the reception performance calculated in step S32 exceeds the maximum data rate related to the data reception set as the “data size of the data capable of being received in the certain time.” Here, let it be assumed that the data size of the data received by the network adapter 30 via the transmission path 30 is increased and the reception performance calculated in step S32 is increased. In this case, if the reception performance exceeds the maximum data rate related to the data reception (Yes in step S33), the flow proceeds to step S36. In step S36, the firmware 31 is configured not to transfer the data related to the reception in step S31 to the main body part 10 but to temporarily store the same in the predetermined queue. If the queue is full of data items, the received data are abandoned by the network adapter 30. The abandoned data are either subjected to retransmission processing according to the protocol operation of a data transmission source or treated as lost data.

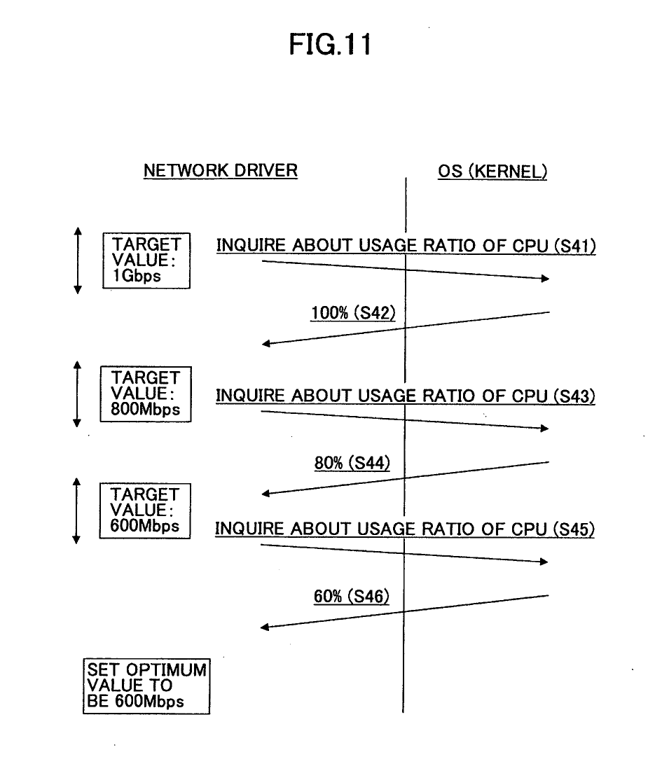

FIG. 11 is a sequence diagram for illustrating an actual example of the operations in accordance with the procedures (3) through (5) described above. In the case of this example, the user sets the upper limit of the usage ratio of the CPU 14 to be 60% in accordance with the procedure (1) described above. In addition, the user sets the initial value of the maximum data rate related to the data transmission/reception to be 1 Gbps and the reduction range of the maximum data rate to be 200 Mbps.

In FIG. 11, the network driver 12 acquires the usage ratio of the CPU 14 in accordance with the procedure (5) described above, i.e., the operations of steps S1 through S3 in FIG. 7 (steps S41 and S42). Here, let it be assumed that the usage ratio of the CPU 14 thus acquired is 100% as illustrated in FIG. 11 (step S42). Since the usage ratio of the CPU 14 exceeds the maximum value 60% (Yes in step S4 of FIG. 7), the network driver 12 reduces the setting value of the maximum data rate by the reduction range 200 Mbps (i.e., 1 Gbps−200 Mbps=800 Mbps) (step S5 of FIG. 7).

The network driver 12 acquires the usage ratio of the CPU 14 again (steps S43 and S44). Here, let it be assumed that the usage ratio of the CPU 14 thus acquired is 80% (step S44). Since the usage ratio of the CPU 14 still exceeds the maximum value 60%, the network driver 12 reduces the setting value of the maximum data rate by the reduction range 200 Mbps (i.e., 800 Gbps−200 Mbps=600 Mbps).

The network driver 12 acquires the usage ratio of the CPU 14 again (steps S45 and S46). Let it be assumed that the usage ratio of the CPU 14 thus acquired is 60% (step S46). Since the usage ratio of the CPU 14 matches the upper limit 60% (No in step S4 of FIG. 7), the network driver 12 determines the setting value (600 Mbps) of the current maximum data rate as an optimum value and maintains the same. The network driver 12 repeatedly performs this processing.

The information processing apparatus according to the embodiment repeatedly performs the processing as described above, thereby making it possible to acquire the setting value of the optimum maximum data rate in accordance with the performance of the CPU 14 of the main body part 10 of the information processing apparatus where the network adapter 30 is mounted. Accordingly, the information processing apparatus can reduce excessive consumption of a CPU resource, which in turn effectively prevents the processing of data (i.e., non-communication data) other than the communication data from being disturbed.

(6) Display of Maximum Data Rate

In the case of No in step S4 of the procedure (5) described above, i.e., the operation of FIG. 7, the network driver 12 acquires the respective setting values of the maximum data rate related to the data transmission and the maximum data rate related to the data reception. The setting values are reported to the user via the command or the like processed by the application 11 as “optimum maximum data rates.” The user can set the values in the information processing apparatus in advance. As a result, the user can set the optimum maximum data rates at the activation of the information processing apparatus by skipping the procedures (3) through (5) described above. In other words, the user sets the optimum maximum data rate related to the data transmission in the network driver 12 and the optimum maximum data rate related to the data reception in the firmware 31 of the network adapter 30.

The maximum data rate related to the data transmission corresponds to the target value of the transmission performance in step S13 of FIG. 8. Accordingly, if the CPU 14 of the main body part 10 performs the processing of transmitting the data size of the data exceeding the maximum data rate set by the user, the result of the determination in step S13 is Yes. As a result, the network driver 12 performs the processing of step S16 in FIG. 8 to stop the data transmission.

Similarly, the maximum data rate related to the data reception corresponds to the target value of the reception performance in step S33 of FIG. 10. Accordingly, if the CPU 14 of the main body part 10 performs the processing of receiving the data size of the data exceeding the maximum data rate set by the user, the result of the determination in step S33 is Yes. As a result, the network driver 12 performs the processing of step S36 in FIG. 10 to stop the data reception.

As described above, controlling the processing of the communication data prevents an excessive load from being placed on the CPU 14. Accordingly, it is possible to operate the information processing apparatus with the optimum data transmission/reception sizes and the optimum usage ratio of the CPU 14.

Note that the information processing apparatus according to the embodiment has the following configuration as described above with reference to FIG. 7 and the like. In other words, if the usage ratio of the CPU 14 related to the operation of the measured data transmission function exceeds the upper limit, the information processing apparatus reduces the maximum data rate related to the data transmission by the predetermined rate. This configuration is simply referred to as a “configuration for controlling the data transmission.” Moreover, the information processing apparatus has the following configuration as described above with reference to FIG. 7 and the like. In other words, if the usage ratio of the CPU 14 related to the operation of the measured data reception function exceeds the upper limit, the information processing apparatus reduces the maximum data rate related to the data reception by the predetermined rate. This configuration is simply referred to as a “configuration for controlling the data reception.” However, the information processing apparatus is not necessarily limited to the configurations of the embodiment.

In other words, the information processing apparatus according to a first modification may have the following configuration. This information processing apparatus has the configuration for controlling the data transmission but does not have the configuration for controlling the data reception.

Further, the information processing apparatus according to a second modification may have the following configuration. This information processing apparatus does not have the configuration for controlling the data transmission but has the configuration for controlling the data reception.

Further, in the information processing apparatus according to the embodiment, the network driver 12 having the respective configurations of the data transmission function and the data reception function is provided in the main body part 10 as described above with reference to FIGS. 1, 2, and the like. Further, as described above with reference to FIGS. 1, 2, and the like, the information processing apparatus is provided with the network adapter 30 including the firmware 31 configured to receive data via the transmission path 50 and transfer the same to the main body part 10. However, the information processing apparatus is not necessarily limited to the configurations of the embodiment.

In other words, the information processing apparatus according to a third modification may have the following configuration. In this information processing apparatus, the network adapter 30 is included in the main body part 10. That is, the information processing apparatus is configured to provide one CPU in the main body part 10 instead of providing the CPU 14 in the main body part 10 and the CPU 35 in the network adapter 30. Further, in the above embodiment, the two types of software programs for processing the communication data, i.e., the network driver 12 of the main body part 10 and the firmware 31 of the network adapter 30, are installed. Instead of this configuration, the information processing apparatus is configured to install one software program for processing the communication data in the main body part 10. Here, the one software program for processing the communication data also has the configuration of the two types of software programs for processing the communication data. In addition, the information processing apparatus according to the embodiment also has the configuration for controlling the data transmission and the configuration for controlling the data reception. Instead of this, the information processing apparatus may have either the configuration for controlling the data transmission or the configuration for controlling the data reception.

All examples and conditional language recited herein are intended for pedagogical purposes to aid the reader in understanding the present invention and the concepts contributed by the inventor to furthering the art, and are to be construed as being without limitation to such specifically recited examples and conditions, and the organization of such examples in the specification does not relate to a showing of the superiority or inferiority of the present invention. Although the embodiment of the present invention has been described in detail, it should be understood that the various changes, substitutions, and alterations could be made hereto without departing from the spirit and scope of the present invention.

What is claimed is:

1. An information processing apparatus comprising:
a communication unit connected to a transmission path and performs transmission and reception of communication data via the transmission path;
a processing unit that performs processing of the communication data and non-communication data serving as data other than the communication data;
a processing unit control part that causes the processing unit to perform the processing of the communication data and the non-communication data; and
a communication unit control part that controls the communication unit, acquires a usage ratio that represents a ratio of time required for performing the processing per unit time when the processing unit performs the processing of the communication data from the processing unit control part, and sets a maximum data rate that represents a maximum value of a data transfer amount per unit time to perform the transmission and reception of the communication data based on the acquired usage ratio.

2. The information processing apparatus according to claim 1, wherein
the communication unit control part acquires the usage ratio from the processing unit control part every elapse of a predetermined time.

3. The information processing apparatus according to claim 1, wherein
the communication unit control part reduces the maximum data rate by a predetermined rate when the usage ratio acquired from the processing unit control part exceeds a predetermined value.

4. The information processing apparatus according to claim 1, wherein
the communication unit control part calculates a transfer rate of the communication unit by periodically initializing a transmission data size sum that represents a sum of sizes of the transmission data relating to the transmission and a reception data size sum that represents a sum of sizes of the communication data relating to the reception.

5. The information processing apparatus according to claim 4, wherein
the sum of the sizes of the communication data relating to the transmission is a sum of sizes of communication data transmitted by the communication unit and is calculated every time the communication unit control part performs the transmission of the communication data, and
the sum of the sizes of the communication data relating to the reception is a sum of sizes of communication data received by the communication unit and transferred to the communication unit control part and is calculated every time the communication unit transfers the communication data.

6. The information processing apparatus according to claim 1, wherein
the communication unit control part sets the maximum data rate in the communication unit control part in a case of performing the transmission of the communication data.

7. The information processing apparatus according to claim 1, wherein
the communication unit control part sets the maximum data rate in the communication unit in a case of performing the reception of the communication data.

8. A method for controlling an information processing apparatus having a communication unit that is connected to a transmission path and performs transmission and reception of communication data via the transmission path and a processing unit that performs processing of the communication data and non-communication data serving as data other than the communication data, the method comprising:
causing the processing unit to perform the processing of the communication data and the non-communication data; and
controlling the communication unit, acquiring a usage ratio that represents a ratio of time required for performing the processing per unit time when the processing unit performs the processing of the communication data from the causing, and setting a maximum data rate that represents a maximum value of a data transfer amount per unit time to perform the transmission and reception of the communication data based on the acquired usage ratio.

9. The method according to claim 8, wherein
the controlling, the acquiring, and the setting acquire the usage ratio from the causing every elapse of a predetermined time.

10. The method according to claim 8, wherein
the controlling, the acquiring, and the setting reduce the maximum data rate by a predetermined rate when the usage ratio acquired from the causing exceeds a predetermined value.

11. The method according to claim 8, wherein
the controlling, the acquiring, and the setting calculate a transfer rate of the communication unit by periodically initializing a transmission data size sum that represents a sum of sizes of the transmission data relating to the transmission and a reception data size sum that represents a sum of sizes of the communication data relating to the reception.

12. The method according to claim 11, wherein
the sum of the sizes of the communication data relating to the transmission is a sum of sizes of communication data transmitted by the communication unit and is calculated every time the controlling, the acquiring, and the setting perform the transmission of the communication data, and
the sum of the sizes of the communication data relating to the reception is a sum of sizes of communication data received by the communication unit and transferred to the controlling, the acquiring, and the setting and is calculated every time the communication unit transfers the communication data.

13. The method according to claim 8, wherein
the controlling, the acquiring, and the setting set the maximum data rate in the controlling, the acquiring, and the setting in a case of performing the transmission of the communication data.

14. The method according to claim 8, wherein
the controlling, the acquiring, and the setting set the maximum data rate in the communication unit in a case of performing the reception of the communication data.

15. A non-transitory computer readable information recording medium having stored therein a program that is executed by a computer processor that controls an operation of an information processing apparatus having a communication unit connected to a transmission path and performs transmission and reception of communication data via the transmission path and a processing unit that performs processing of the communication data and non-communication data serving as data other than the communication data, the program, when executed by the computer processor, carrying out:
causing the processing unit to perform the processing of the communication data and the non-communication data; and
controlling the communication unit, acquiring a usage ratio that represents a ratio of time required for performing the processing per unit time when the processing unit performs the processing of the communication data from the causing, and setting a maximum data rate that represents a maximum value of a data transfer amount per unit time to perform the transmission and reception of the communication data, based on the acquired usage ratio.

16. The non-transitory computer readable information recording medium having stored therein the program according to claim 15, wherein
the controlling, the acquiring, and the setting acquire the usage ratio from the causing every elapse of a predetermined time.

17. The non-transitory computer readable information recording medium having stored therein the program according to claim 15, wherein
the controlling, the acquiring, and the setting reduce the maximum data rate by a predetermined rate when the usage ratio acquired from the causing exceeds a predetermined value.

18. The non-transitory computer readable information recording medium having stored therein the program according to claim 15, wherein
the controlling, the acquiring, and the setting calculate a transfer rate of the communication unit by periodically initializing a transmission data size sum that represents a sum of sizes of the transmission data relating to the transmission and a reception data size sum that represents a sum of sizes of the communication data relating to the reception.

19. The non-transitory computer readable information recording medium having stored therein the program according to claim 18, wherein
the sum of the sizes of the communication data relating to the transmission is a sum of sizes of communication data transmitted by the communication unit and is calculated every time the controlling, the acquiring, and the setting perform the transmission of the communication data, and
the sum of the sizes of the communication data relating to the reception is a sum of sizes of communication data received by the communication unit and transferred to the controlling, the acquiring, and the setting and is calculated every time the communication unit transfers the communication data.

20. The non-transitory computer readable information recording medium having stored therein the program according to claim 15, wherein
the controlling, the acquiring, and the setting set the maximum data rate in the controlling, the acquiring, and the setting in a case of performing the transmission of the communication data.
